(19) United States
(12) Patent Application Publication
(10) Pub. No.: US 2026/0370769 A1
(43) Pub. Date: Nov. 19, 2026

(54) CONTROL DEVICE, CONTROL METHOD, STORAGE MEDIUM, IMAGE FORMING APPARATUS, AND IMAGE FORMING METHOD

(71) Applicant: KONICA MINOLTA, INC., Tokyo (JP)

(72) Inventor: Yoshito HASHIMURA, Kawasaki-shi (JP)

(73) Assignee: KONICA MINOLTA, INC., Tokyo (JP)

(21) Appl. No.: 19/670,958

(22) Filed: May 7, 2026

(30) Foreign Application Priority Data
May 14, 2025 (JP) 2025-081286

(51) Int. Cl. H04N 1/48; B41J 2/21; B41J 3/44; B41J 11/00; B41J 11/66; G06K 15/00; G06K 15/02; H04N 1/00; H04N 1/12

(52) U.S. Cl. CPC H04N 1/48; B41J 2/2135; B41J 3/44; B41J 11/0035; B41J 11/66; G06K 15/1868; G06K 15/4065; H04N 1/00795; H04N 1/1215; G06K 2215/0094; G06K 2215/101; H04N 2201/0081

(57) ABSTRACT

A control device that controls an image forming apparatus to form an image on a recording medium, the control device includes, a hardware processor configured to cause the image to be formed on the recording medium in a state that a color measurement of the image can be performed by a first color measurer provided on a conveyance route on which the recording medium is conveyed. The hardware processor is configured to provide the image with a cutting region for cutting the recording medium on which the image is formed to perform the color measurement of the image in a second color measurer outside the conveyance route.

### CROSS-REFERENCE TO RELATED APPLICATION

The entire disclosure of Japanese Patent Application No. 2025-081286, filed on May 14, 2025, including description, claims, drawings and abstract is incorporated herein by reference.

### BACKGROUND OF THE INVENTION

### Technical Field

The present disclosure relates to a control device, a control method, a storage medium, an image forming apparatus, and an image forming method.

### Description of Related Art

In an image forming apparatus, to maintain image quality, a color measurement image including a plurality of patches is formed on a recording medium, and the color of the image is adjusted by performing color measurement on the color measurement image. Accordingly, the image forming apparatus in which a colorimeter (inline colorimeter) is provided on a conveyance route along which a recording medium after image formation is conveyed is used.

For example, Japanese Unexamined Patent Application Publication No. 2023-034825 discloses a technique in which, in an image reading device that reads a detection image including the color measurement image and a position measurement image, parameters such as a position, an inclination, and a magnification of the color measurement image are obtained based on a reading result of the position measurement image.

However, if a malfunction occurs in the color measurement of a color measurement chart including a plurality of patches by the inline colorimeter provided in an image forming apparatus, the same chart may be subjected to the color measurement by an offline colorimeter. To measure the color measurement chart with the offline colorimeter, it is necessary to cut the recording medium to a size measurable by the offline colorimeter. When the recording medium is cut, if each patch used for the color measurement is also cut, there is a problem in that color measurement accuracy of the offline colorimeter decreases. In addition, there is a problem in that forming the color measurement image again takes extra time.

### SUMMARY OF THE INVENTION

The present disclosure has been made in view of the above-described problems in the related art, and an object of the present disclosure is to allow a colorimeter located outside a conveyance route of a recording medium of an image forming apparatus to easily perform color measurement on an image for color measurement by the colorimeter provided in the conveyance route of the recording medium of the image forming apparatus.

To solve the above-described problem, according to a control device reflecting one aspect of the present disclosure, the control device according to one aspect of the present disclosure is the control device that controls an image forming apparatus to form an image on a recording medium, the control device including:
a hardware processor configured to cause the image to be formed on the recording medium in a state that a color measurement of the image can be performed by a first color measurer provided on a conveyance route on which the recording medium is conveyed,
wherein the hardware processor is configured to provide the image with a cutting region for cutting the recording medium on which the image is formed to perform the color measurement of the image in a second color measurer outside the conveyance route.

According to another aspect of the present disclosure, a control method for controlling an image forming apparatus to form an image on a recording medium, the control method including:
controlling to cause the image to be formed on the recording medium in a state that a color measurement of the image can be performed by a first color measurer provided on a conveyance route on which the recording medium is conveyed,
wherein in the controlling, the image is provided with a cutting region for cutting the recording medium on which the image is formed to perform the color measurement of the image in a second color measurer outside the conveyance route.

According to another aspect of the present disclosure, a non-transitory computer readable storage medium including a control program that causes a computer of a control device that controls an image forming apparatus to form an image on a recording medium to execute the control method described above.

According to another aspect of the present disclosure, an image forming apparatus including:
an image former; and
a control device configured to cause the image former to form an image on a recording medium,
wherein,
the control device includes a hardware processor configured to cause the image to be formed on the recording medium in a state that a color measurement of the image can be performed by a first color measurer provided on a conveyance route on which the recording medium is conveyed, and
the hardware processor is configured to provide the image with a cutting region for cutting the recording medium on which the image is formed to perform the color measurement of the image in a second color measurer outside the conveyance route.

According to another aspect of the present disclosure, an image forming method in which an image forming apparatus forms an image on a recording medium, the image forming method including:
controlling to cause the image to be formed on the recording medium in a state that a color measurement of the image can be performed by a first color measurer provided on a conveyance route on which the recording medium is conveyed,
wherein in the controlling, the image is provided with a cutting region for cutting the recording medium on which the image is formed to perform the color measurement of the image in a second color measurer outside the conveyance route.

### BRIEF DESCRIPTION OF THE DRAWINGS

The advantages and features provided by one or more embodiments of the invention will become more fully understood from the detailed description given hereinafter and the appended drawings which are given by way of illustration only, and thus are not intended as a definition of the limits of the present disclosure, and wherein:

FIG. 1 is a system configuration diagram of an image forming system;

FIG. 2 is a block diagram showing a functional configuration of an image forming apparatus;

FIG. 3 is a block diagram showing an example of a color measurement device;

FIG. 4 is a diagram illustrating an example of a color measurement chart on which a color measurement image including a cutting region is formed;

FIG. 5 is a diagram illustrating a distance between a color measurement sensor and a downstream roller in a conveyance direction of a recording medium;

FIG. 6 is a diagram illustrating the distance between the color measurement sensor and the downstream roller in the conveyance direction of the recording medium;

FIG. 7 is a diagram illustrating a distance between the color measurement sensor and the downstream roller in the conveyance direction of the recording medium;

FIG. 8 is a diagram illustrating an example of a color measurement chart on which the color measurement image including the cutting region and a cutting line is formed;

FIG. 9 is a flowchart illustrating overall processing during color measurement;

FIG. 10 is a flowchart illustrating a color measurement chart creation process; and

FIG. 11 is a flowchart illustrating color measurement processing.

### DETAILED DESCRIPTION

Hereinafter, one or more embodiments of the present disclosure will be described with reference to the drawings. However, the scope of the invention is not limited to the disclosed embodiments.

Hereinafter, embodiments of the present disclosure will be described with reference to the drawings. Advantages and features provided by the embodiments will be understood from the following detailed description and the accompanying drawings. However, the present disclosure is not limited to the embodiments disclosed below or the examples illustrated in the drawings. In addition, dimensional ratios in the drawings are exaggerated for convenience of description and may differ from actual ratios.

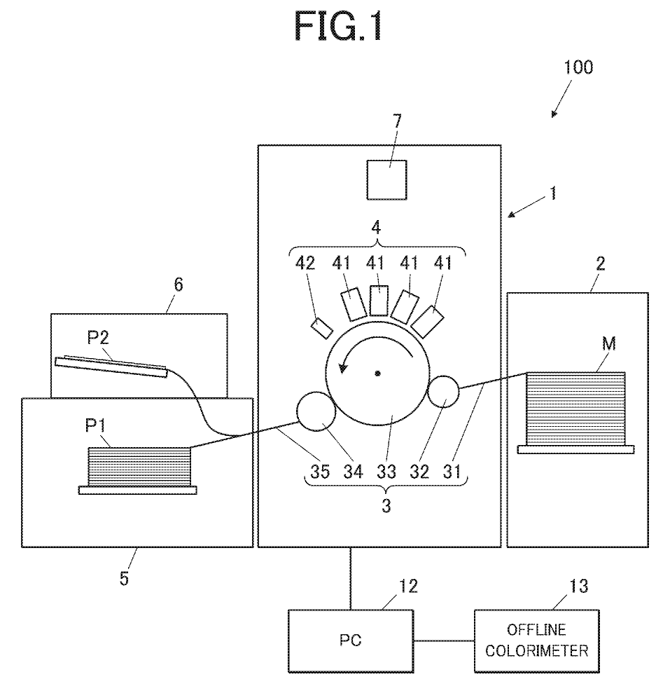

FIG. 1 is a system configuration diagram of an image forming system 100. The image forming system 100 includes an image forming apparatus 1, a personal computer (PC) 12, and an offline colorimeter 13. The image forming apparatus 1 and the PC 12 are communicatively connected to each other via a communication network such as a local area network (LAN).

The image forming apparatus 1 forms an image on a recording medium M.

The PC 12 performs color management (e.g., color adjustment and color verification) of the image forming apparatus 1.

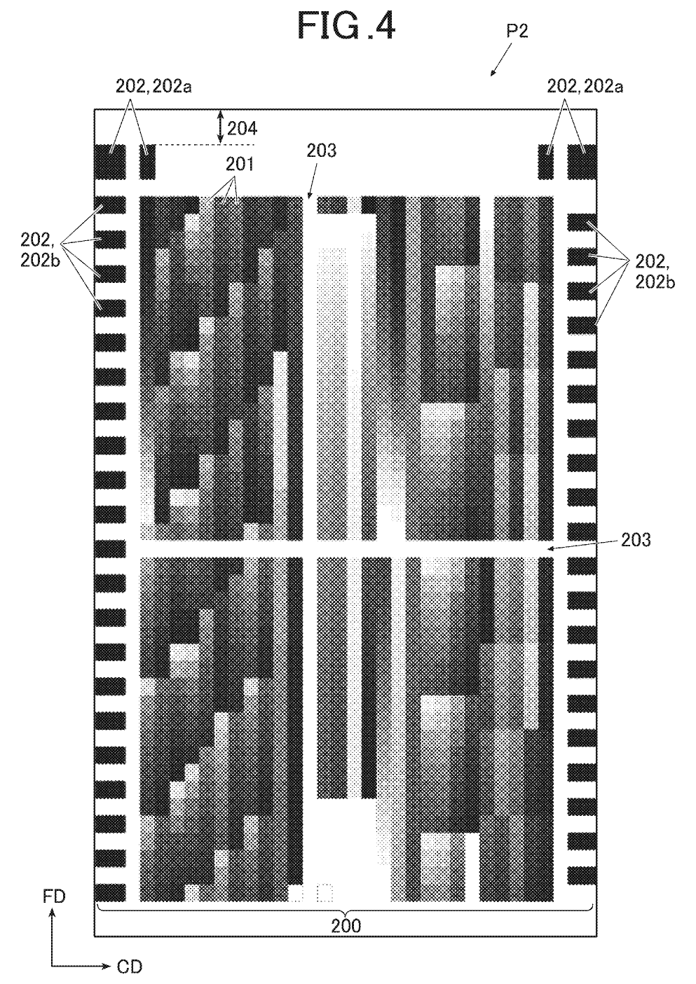

The offline colorimeter 13 (second color measurer) is connectable to the PC 12 via a universal serial bus (USB) cable or the like. The offline colorimeter 13 measures a color of a color measurement patch 201 (see FIG. 4) included in a chart on which a color measurement image is formed by the image forming apparatus 1, and outputs a colorimetric value (e.g., an L^{*}a^{*}b^{*} value). A spectrophotometer can be used as the offline colorimeter 13. The offline colorimeter 13 is used as an auxiliary device when a malfunction occurs in a color measurement by a color measurement device 6 (first color measurer) in the image forming apparatus 1. The offline colorimeter 13 may be a colorimeter provided with an automatic sheet feed device or a flatbed colorimeter.

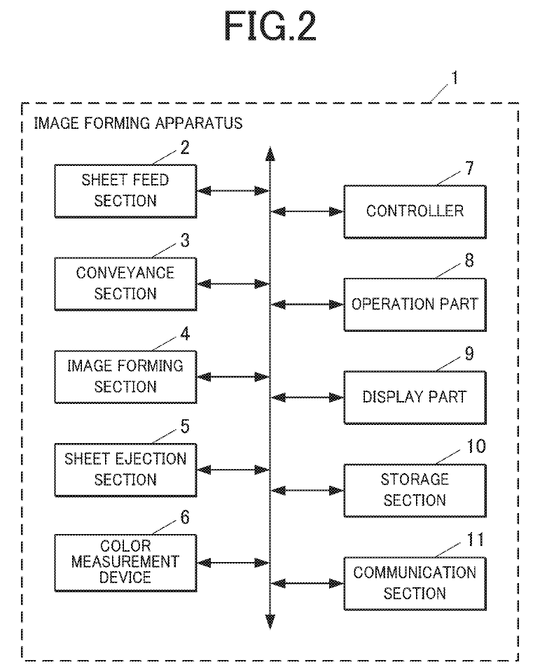

FIG. 2 is a block diagram illustrating a functional configuration of the image forming apparatus 1. The image forming apparatus 1 includes a sheet feed section 2, a conveyance section 3, an image forming section (image former) 4, a sheet ejection section 5, a color measurement device 6, a controller (hardware processor) 7, an operation part 8, a display part 9, a storage section 10, and a communication section 11.

The sheet feed section 2 includes a sheet feed tray that stores a recording medium M and supplies the recording medium M to the image forming section 4. Examples of the recording medium M include a printing sheet, a film (sheet-shaped resin), textile, and the like. Examples of the printing sheet include plain paper, coated paper, and colored paper.

The conveyance section 3 conveys the recording medium M. As shown in FIG. 1, the conveyance section 3 includes a feeder board 31, a first handover drum 32, a conveyance drum 33, a second handover drum 34, and a carrying-out section 35.

The feeder board 31 conveys the recording medium M from the sheet feed section 2 to the first handover drum 32. The first handover drum 32 holds and picks up one end of the recording medium M conveyed by the feeder board 31, and transfers the recording medium M to the conveyance drum 33.

The conveyance drum 33 is, for example, cylindrical. A side circumferential surface of the conveyance drum 33 serves as a transport surface that holds the recording medium M by suction. The conveyance drum 33 rotates in one direction about a central axis as a rotation axis while holding the recording medium M on the transport surface. Accordingly, the conveyance drum 33 transports the recording medium M, which is held by suction on the transport surface, along the transport surface.

The image forming section 4 includes one or a plurality of head units 41. The image forming section 4 produces printed material using an inkjet method. The head unit 41 includes an ink ejection face at a position facing the transport surface of the conveyance drum 33. The head unit 41 ejects ink onto the recording medium M held on the conveyance drum 33 at appropriate timing in accordance with a rotation of the conveyance drum 33 to form the image, thereby producing the printed material (e.g., normal printed material P1 and color measurement chart P2). The ink is not particularly limited, however, for example, an ultraviolet-curable ink may be used.

In the image forming apparatus 1 illustrated in FIG. 1, four head units 41 are arranged at predetermined intervals in order from an upstream side in a rotation direction of the conveyance drum 33. The four head units 41 respectively correspond to, for example, four colors of ink, yellow, magenta, cyan, and black. The image forming section 4 includes an ultraviolet irradiation section 42 downstream of the head unit 41 in a conveyance direction of the recording medium M. The ultraviolet irradiation section 42 irradiates ultraviolet light, thereby curing the ink on the recording medium M.

The image forming section 4 performs print jobs, such as a normal job or a color measurement job. The normal job is the print job for producing normal printed material P1 that is not subject to the color measurement. The color measurement job is the print job for producing the color measurement chart P2 on which the color measurement image is formed.

The second handover drum 34 holds one end of the printed material P conveyed by the conveyance drum 33, picks up the printed material P, and hands over the printed material P to the carrying-out section 35. The carrying-out section 35 is a carrying-out path for the printed material (recording medium M on which the image is formed), and conveys the printed material to the sheet ejection section 5 or the color measurement device 6. Specifically, the carrying-out section 35 conveys the normal printed material P1 produced by the normal job to the sheet ejection section 5, and conveys the color measurement chart P2 produced by the color measurement job to the color measurement device 6. The carrying-out section 35 includes, for example, a belt, a roller, or the like. As shown in FIG. 1, the conveyance route in the carrying-out section 35 may branch midway. The sheet ejection section 5 includes, for example, a sheet ejection tray.

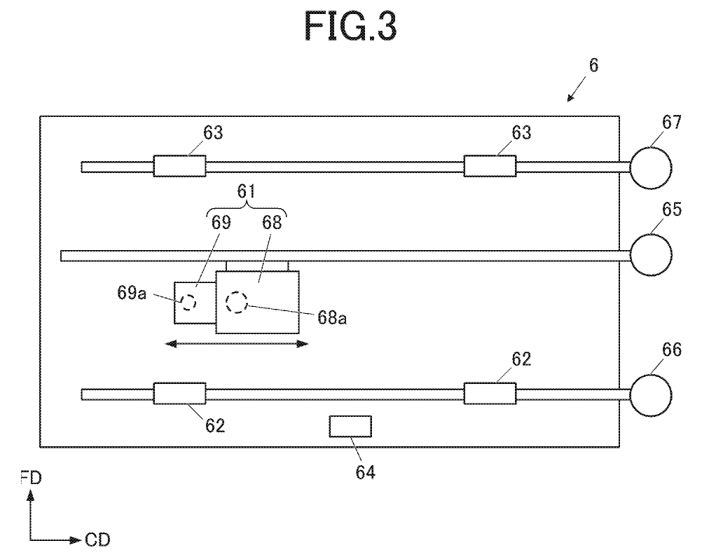

The color measurement device 6 is a device that performs the color measurement on a color measurement chart P2 and is disposed inline in the image forming apparatus 1. That is, the color measurement device 6 is provided in a conveyance route for conveying the color measurement chart P2 (recording medium M). FIG. 3 is a block diagram illustrating an example of the color measurement device 6. As shown in FIG. 3, the color measurement device 6 includes a color measurement head 61, an upstream roller 62, a downstream roller 63, a leading-end detection sensor 64, a first motor 65, a second motor 66, and a third motor 67.

The color measurement head 61 includes a color measurement sensor 68 (reading section, reader), and a position sensor 69.

The color measurement sensor 68 optically detects and performs the color measurement on a color measurement patch 201 (see FIG. 4). The color measurement is measuring color information, and is measuring the colorimetric value such as an L*a*b* value. As the color measurement sensor 68, for example, a spectrophotometer can be used that performs the color measurement by spectrally dispersing reflected light from the color measurement patch 201. The color measurement sensor 68 includes a reading region 68a on a surface facing a color measurement chart P2, and performs the color measurement on the color measurement patch 201 corresponding to the reading region 68a. The color measurement device 6 may be provided with a white calibration plate, and the color measurement sensor 68 may be calibrated by reading a white calibration plate at a predetermined timing.

The position sensor 69 detects a position patch 202 (see FIG. 4). The position sensor 69 is, for example, mechanically attached adjacent to the color measurement sensor 68, and is movable together with the color measurement sensor 68. The position sensor 69 is preferably a single-wavelength reflective fiber-optic sensor or a reflective color sensor. For example, the position sensor 69 detects the position patch 202 based on a difference between an amount of light received in a white region and an amount of light received in a black region. The position sensor 69 includes a reading region 69a on a surface facing the color measurement chart P2, and detects a position patch 202 corresponding to the reading region 69a.

The upstream roller 62 is a conveyance roller provided upstream of the color measurement head 61 in the conveyance direction of the recording medium M (color measurement chart P2). The downstream roller 63 is a conveyance roller provided downstream of the color measurement head 61 in the conveyance direction of the recording medium M. The upstream roller 62 and the downstream roller 63 convey the color measurement chart P2 in a sub-scanning direction (FD direction, Feed Direction) orthogonal to the main scanning direction.

The leading-end detection sensor 64 detects the leading end of the conveyed recording medium M (color measurement chart P2).

The first motor 65 reciprocates the color measurement head 61 in the main scanning direction (CD direction, Cross Direction).

The second motor 66 is a motor for rotating the upstream roller 62.

The third motor 67 is a motor for rotating the downstream roller 63.

The controller 7 controls operations of the respective units constituting the image forming apparatus 1. The controller 7 is a control device configured to cause the image forming apparatus 1 to form the image on the recording medium M based on image data, print settings, and the like. The controller 7 is a computer and includes, for example, a Central Processing Unit (CPU), a Random Access Memory (RAM), and a Read Only Memory (ROM). The CPU executes various control programs, to drive and control the image forming apparatus 1 and to perform various arithmetic processes. The RAM provides a working memory space for the CPU and stores temporary data. The ROM stores various control programs to be executed by the CPU, setting data, and the like. A rewritable non-volatile memory, such as a flash memory, may be used in place of the ROM. The controller 7 may be an external device, such as a personal computer (PC).

The controller 7 generates print data based on a print job, such as a normal job or a color measurement job. Specifically, the controller 7 performs Raster Image Processing (RIP) on the image data to generate raster data. The controller 7 also performs image processing, such as color conversion and screening, on the image data. The print data need not necessarily be generated by the controller 7, and may be data stored in advance. The controller 7 controls operations of the conveyance section 3, the image forming section 4, and the like to produce the printed material. Specifically, the controller 7 performs image processing, head unit drive control, ultraviolet irradiation control, conveyance control, color measurement processing, and the like.

The operation part 8 includes a touch screen, a numeric keypad, a start button, a stop button, and the like. The operation part 8 receives various operations from the user and outputs, to the controller 7, an operation signal based on the operation. For example, the operation part 8 is used when a user inputs various print settings, information for creating an ICC profile, and the like.

The display part 9 includes a liquid crystal display (LCD) or the like, and displays various screens in accordance with a display signal input from the controller 7.

The storage section 10 includes a hard disk drive (HDD), a solid-state drive (SSD), nonvolatile memory, and the like. The storage section 10 stores various data, such as parameters and files, that are necessary for executing various processes.

The communication section 11 includes a network interface or the like. The communication section 11 transmits and receives data to and from an external device, such as a PC 12, connected via a communication network.

FIG. 4 is a diagram illustrating an example of the color measurement chart P2 on which a color measurement image 200 is formed. The color measurement image 200 includes a plurality of color measurement patches 201 and a plurality of position patches 202.

The plurality of color measurement patches 201 are arranged to form a plurality of columns in the CD direction and a plurality of rows in the FD direction. Among the plurality of rows, the row on a leading-end side (upper side in FIG. 4) is a first row. As used herein, the leading-end side refers to the leading-end side in the conveyance direction of the color measurement chart P2.

The plurality of position patches 202 include a CD position patch 202a and an FD position patch 202b. The CD position patch 202a is the position patch 202 mainly intended to indicate position information in the CD direction. The FD position patch 202b is a position patch 202 mainly intended to indicate the position information in the FD direction.

The plurality of CD position patches 202a are arranged on the leading-end side of the color measurement patch 201 and are spaced apart from each other in the CD direction. Based on the position and size of the CD position patch 202a, the length of the color measurement patch 201 in the CD direction and the range corresponding to one row of the color measurement patch 201 in the CD direction can be determined.

The plurality of FD position patches 202b are arranged on either one or both of the left and right sides of the color measurement patch 201, and are spaced apart from each other in the FD direction. Each FD position patch 202b is arranged such that its position in the FD direction coincides with a respective row of the color measurement patch 201. Specifically, each FD position patch 202b arranged in the FD direction on the left side of the color measurement patch 201 is arranged such that its position in the FD direction coincides with the position in the FD direction of a respective odd-numbered row of the color measurement patch 201. Each FD position patch 202b arranged in the FD direction on the right side of the color measurement patch 201 is arranged such that its position in the FD direction coincides with the position in the FD direction of a respective even-numbered row of the color measurement patch 201. Here, the "left side" refers to the left side as viewed in the conveyance direction of the color measurement chart P2. The "right side" refers to the right side as viewed in the conveyance direction of the color measurement chart P2.

The controller 7 causes the color measurement image 200 (image) to be formed on the recording medium M such that the color measurement device 6 (first color measurer) provided on a conveyance route for conveying the recording medium M can perform the color measurement on the color measurement image 200.

As shown in FIG. 4, the controller 7 provides a cutting region 203 in the color measurement image 200. The cutting region 203 is a region for cutting the recording medium M (color measurement chart P2) on which the color measurement image 200 is formed, in order to perform the color measurement of the color measurement image 200 using an offline colorimeter 13 (second color measurer) provided outside a conveyance route for the recording medium M of the image forming apparatus 1. For example, the controller 7 provides a cutting region 203 in the color measurement image 200 so that the recording medium M can be cut without cutting each color measurement patch 201. In FIG. 4, the cutting region 203 extending in the FD direction and the cutting region 203 extending in the CD direction are provided in the color measurement image 200 so as to divide the color measurement image 200 into four regions.

The cutting region 203 may be a predetermined color such as white, black, or gray. The cutting region 203 may be a region to which a color material such as ink is not applied (base color of the recording medium M). A predetermined pattern may be formed in the cutting region 203.

The cutting region 203 is preferably a region outside a color measurement target in at least one of the color measurement device 6 and the offline colorimeter 13.

The controller 7 determines the cutting region 203 to be provided in the color measurement image 200 based on the size of the recording medium M that can be subjected to the color measurement by the offline colorimeter 13. The size of the recording medium M handled by the image forming apparatus 1 is, for example, B2 size (e.g., a poster). In contrast, the size of the recording medium M that can be subjected to the color measurement by the offline colorimeter 13 is, for example, A4 size, A3 size, or the like.

The controller 7 causes the color measurement image 200 to be formed on the single recording medium M such that the color measurement device 6 can perform the color measurement of the color measurement image 200.

The controller 7 causes a mark (position patch 202) to be formed on the recording medium M to identify a position at which the color measurement device 6 performs the color measurement on the color measurement image 200.

The color measurement image 200 includes rectangles (color measurement patches 201) of a plurality of colors. The controller 7 determines a size of a rectangle based on a size of the color measurement device 6 (in particular, the reading region 68a of the color measurement sensor 68). For example, when a diameter of the reading region 68a of the color measurement sensor 68 is 7 mm, the controller 7 sets the color measurement patch 201 to a 10 mm square.

In the conveyance direction (FD direction) of the recording medium M (color measurement chart P2), the color measurement device 6 includes the color measurement sensor 68 (reading section) and the downstream roller 63 arranged in this order from the upstream side (see FIGS. 3 and 5-7).

Based on the distance, in the conveyance direction, between the color measurement sensor 68 and the downstream roller 63, the controller 7 adjusts the position, in the conveyance direction, of the color measurement image 200 from the leading end of the recording medium M. In this manner, by adjusting the position of the color measurement image 200, the controller 7 causes the color measurement image 200 to be formed on the recording medium M such that the color measurement device 6 can perform the color measurement on the color measurement image 200.

The distance between the color measurement sensor 68 and the downstream roller 63 in the conveyance direction (FD direction) of the recording medium M will be described with reference to FIGS. 5-7.

As shown in FIG. 5, in the conveyance direction, a distance D1 between a center of the reading region 68a of the color measurement sensor 68 and a center (nip) of the downstream roller 63 may be defined as the distance between the color measurement sensor 68 and the downstream roller 63.

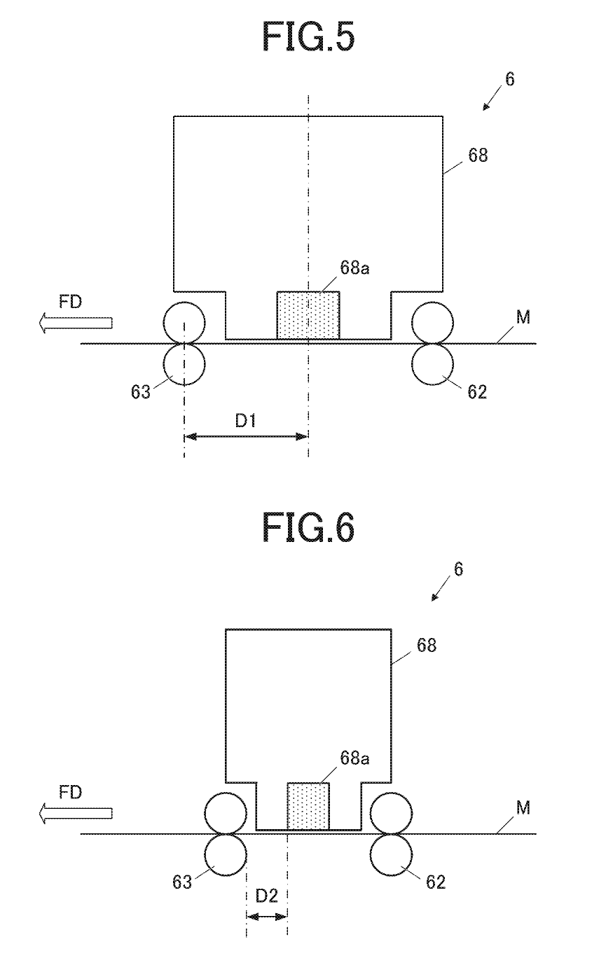

As shown in FIG. 6, in the conveyance direction, a distance D2 between a downstream side end of the reading region 68a of the color measurement sensor 68 and an upstream side end of the downstream roller 63 may be defined as a distance between the color measurement sensor 68 and the downstream roller 63.

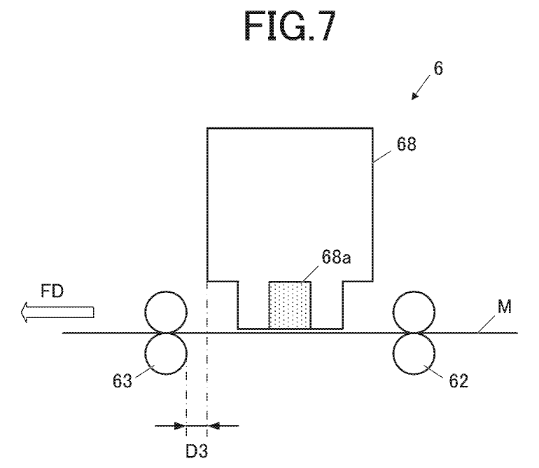

As shown in FIG. 7, in the conveyance direction, a distance D3 between a downstream end of the entire color measurement sensor 68 and an upstream end of the downstream roller 63 may be defined as the distance between the color measurement sensor 68 and the downstream roller 63.

The distance between the color measurement sensor 68 and the downstream roller 63 in the conveyance direction of the recording medium M is not limited to the illustrated example. Which portion of the color measurement sensor 68 and which portion of the downstream roller 63 are used to define the distance between the color measurement sensor 68 and the downstream roller 63 can be changed as desired.

The adjustment of the "position of the color measurement image 200 from the leading end of the recording medium M in the conveyance direction" is, for example, an adjustment of how large a margin 204 (see FIG. 4) is left from the leading end of the recording medium M when the color measurement image 200 is placed when creating the color measurement chart P2. In FIG. 4, a distance between the leading end of the recording medium M and a formation start position of the color measurement image 200 including the CD position patch 202a is defined as the margin 204. Alternatively, a distance between the leading end of the recording medium M and the formation start position of the color measurement patch 201 may be treated as a margin.

The controller 7 adjusts, based on the size of the downstream roller 63, the position of the color measurement image 200 from the leading end of the recording medium M in the conveyance direction, thereby causing the color measurement image 200 to be formed on the recording medium M such that the color measurement device 6 can perform the color measurement on the color measurement image 200. The size of the downstream roller 63 can be determined based on a radius or curvature of the downstream roller 63. That is, the controller 7 may adjust, based on the radius or curvature of the downstream roller 63, the position of the color measurement image 200 relative to a leading end of the recording medium M in the conveyance direction. Specifically, as the radius of the downstream roller 63 increases, the size of the downstream roller 63 increases. Further, as the curvature of the surface of the downstream roller 63 decreases, the downstream roller 63 is larger.

When the distance, in the conveyance direction of the recording medium M, between the color measurement sensor 68 and the downstream roller 63 equals 0, the controller 7 may adjust, based on the radius or curvature of the downstream roller 63, a position of the color measurement image 200 relative to the leading end of the recording medium M in the conveyance direction. The case where the distance, in the conveyance direction of the recording medium M, between the color measurement sensor 68 and the downstream roller 63 is 0 is, for example, a case where the distance D3 shown in FIG. 7 is 0. In addition, in the conveyance direction of the recording medium M shown in FIG. 6, when a reading region 68a of the color measurement sensor 68 extends over the entire surface of the color measurement sensor 68 that faces the recording medium M, the distance D2 may also be 0.

The controller 7 adjusts, based on the paper type of the recording medium M, the position of the color measurement image 200 from the leading end of the recording medium M in the conveyance direction, thereby causing the color measurement image 200 to be formed on the recording medium M such that the color measurement device 6 can perform the color measurement of the color measurement image 200.

When thin paper is used as the recording medium M, the controller 7 adjusts the position of the color measurement image 200 such that the distance, in the conveyance direction, from the leading end of the recording medium M to the color measurement image 200 is longer than when the plain paper or thick paper is used as the recording medium M. The distance from the leading end of the recording medium M to the color measurement image 200 corresponds to the margin 204 shown in FIG. 4. Regarding the paper type, classifications such as the thin paper, the plain paper, and the thick paper are assumed to be predetermined based on the basis weight, thickness, and the like of the recording medium M. In addition, the user may be allowed to change ranges of the basis weight, thickness, and the like of the recording medium M that fall within classifications such as the thin paper, the plain paper, and the thick paper.

Furthermore, the controller 7 may adjust the position of the color measurement image 200 in consideration of the reading region 68a (reading range) of the color measurement sensor 68, a length of the color measurement sensor 68 in the conveyance direction, transport variation of the recording medium M, component variation, an inclination of the recording medium M, and the like. Such adjustment improves color measurement accuracy of the color measurement sensor 68.

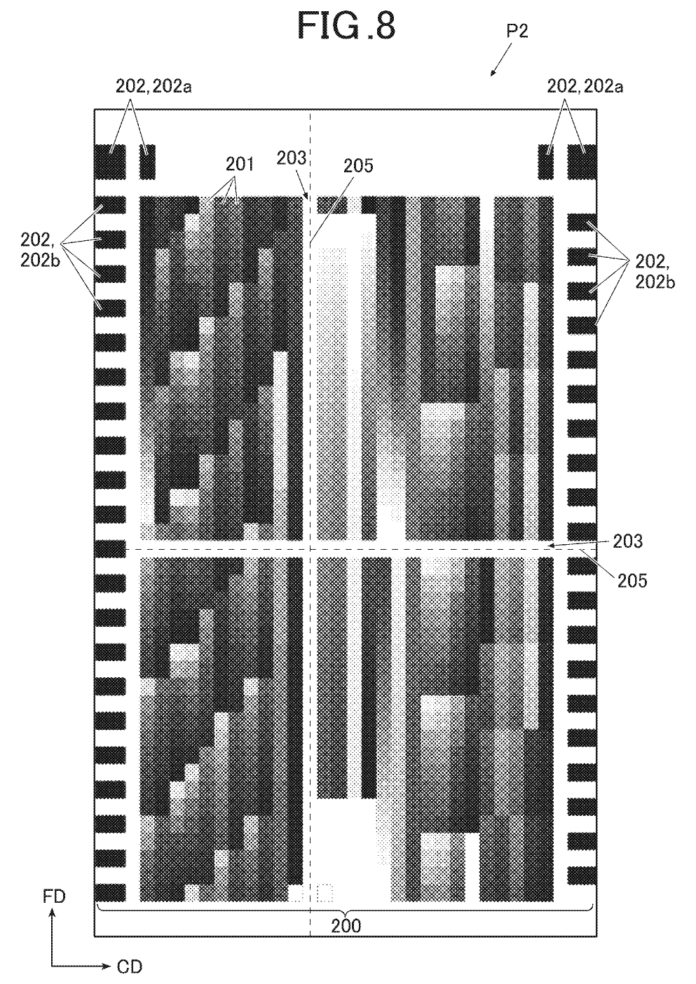

The controller 7 provides, on the color measurement image 200, a cutting line for cutting the cutting region 203. For example, the controller 7 provides, in the cutting region 203 within the color measurement image 200, a broken line, a solid line, or the like as the cutting line. FIG. 8 illustrates an example of the color measurement image 200 provided with a cutting line 205.

Next, the operation of the image forming apparatus 1 will be described.

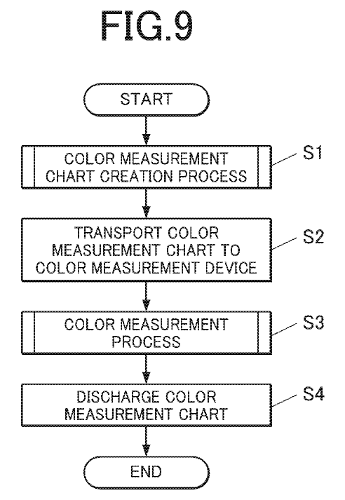

FIG. 9 is a flowchart illustrating overall processing performed during the color measurement. This process is implemented through cooperation between the CPU of the controller 7 and a program stored in the ROM.

First, the controller 7 performs a color measurement chart creation process (step S1).

Next, the controller 7 controls the conveyance section 3 to convey the color measurement chart P2 to the color measurement device 6 (step S2).

Next, the controller 7 performs the color measurement processing on the color measurement chart P2 (step S3).

Next, the controller 7 ejects the color measurement chart P2 (step S4).

Thus, the overall processing during the color measurement is completed.

The controller 7 may perform control related to color adjustment, such as color calibration and ICC profile creation, based on colorimetric data obtained in the color measurement processing (step S3).

The controller 7 may transmit, via the communication section 11, the colorimetric data obtained in the color measurement processing to the PC 12.

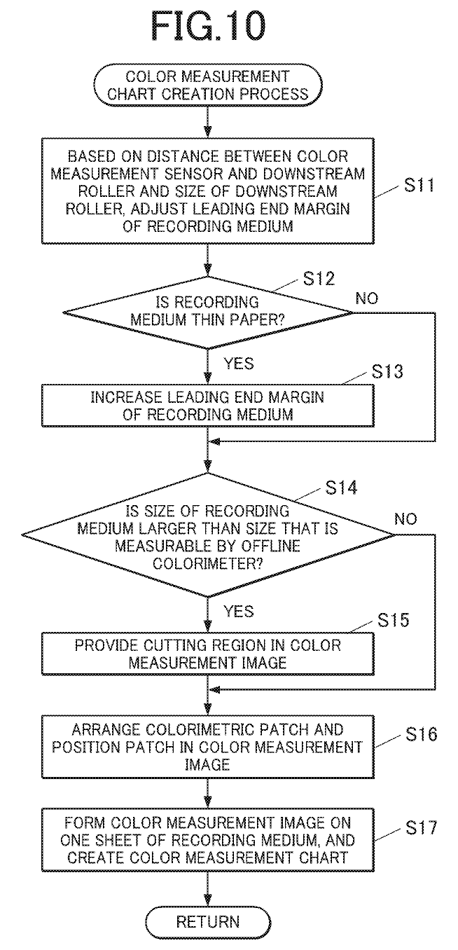

FIG. 10 is a flowchart showing details of the color measurement chart creation process in step S1.

First, the controller 7 adjusts the margin 204 of the leading end of the recording medium M in the color measurement chart P2 based on a distance between the color measurement sensor 68 and the downstream roller 63 and a size of the downstream roller 63 (step S11). For example, the controller 7 increases the margin 204 of the leading end of the recording medium M in the color measurement chart P2 as the distance between the color measurement sensor 68 and the downstream roller 63 increases. The controller 7 increases the margin 204 of the leading end of the recording medium M in the color measurement chart P2 as the size of the downstream roller 63 increases.

Next, the controller 7 determines whether the recording medium M on which the color measurement chart P2 is to be created is thin paper (step S12). For example, the controller 7 acquires paper type information stored in the storage section 10 and determines whether the recording medium M on which the color measurement chart P2 is to be created is thin paper. A sensor configured to detect characteristics of the recording medium M may be provided in the conveyance route or the sheet feed tray of the sheet feed section 2, and the controller 7 may determine whether the recording medium M on which the color measurement chart P2 is to be created is thin paper based on an output from the sensor.

If the recording medium M on which the color measurement chart P2 is to be created is thin paper (YES in step S12), the controller 7 increases the margin 204 of the leading end of the recording medium M in the color measurement chart P2 (step S13).

After step S13, or, in step S12, if the recording medium M on which the color measurement chart P2 is to be created is not thin paper (step S12; NO), the process proceeds to step S14. In step S14, the controller 7 determines whether the size of the recording medium M on which the color measurement chart P2 is to be created is larger than the size measurable by the offline colorimeter 13. Sizes (A4, A3, and the like) measurable by the offline colorimeter 13 are stored in advance in the storage section 10.

If the size of the recording medium M on which the color measurement chart P2 is to be created is larger than a size measurable by the offline colorimeter 13 (step S14: YES), the controller 7 provides the cutting region 203 in the color measurement image 200 (step S15). Specifically, the controller 7 provides the cutting region 203 in the color measurement image 200 such that the recording medium M after cutting has a size measurable by the offline colorimeter 13 (see FIG. 4). Further, the controller 7 may provide the cutting line 205 in the color measurement image 200 to indicate a cutting position on the cutting region 203 (see FIG. 8). The controller 7 causes the storage section 10 to store the position information of the cutting region 203. The position information of the cutting region 203 includes information indicating a position of the cutting region 203 in the color measurement chart P2 (color measurement image 200).

After step S15, or in step S14, if the size of the recording medium M on which the color measurement chart P2 is to be created is equal to or smaller than the size measurable by the offline colorimeter 13 (step S14: NO), the process proceeds to step S16. In step S16, the controller 7 arranges the plurality of color measurement patches 201 and the plurality of position patches 202 in the color measurement image 200. Specifically, the controller 7 arranges the plurality of color measurement patches 201 and the plurality of position patches 202 while avoiding the margin 204 and the cutting region 203. For example, the controller 7 arranges the CD position patch 202a on the leading-end side of the color measurement chart P2, relative to the color measurement patch 201, so that a length of each color measurement patch 201 in the CD direction and a range corresponding to one row of the color measurement patches 201 in the CD direction can be determined. The controller 7 arranges FD position patches 202b so as to correspond to the positions of the respective color measurement patches 201 in the FD direction. In this manner, the controller 7 generates the image data for creating the color measurement chart.

Next, the controller 7 controls the conveyance section 3 and the image forming section 4 to form the color measurement image 200 on the single recording medium M based on the image data for creating the color measurement chart, thereby creating the color measurement chart P2 (step S17).

Thus, the color measurement chart creation process ends.

In place of step S11 of the color measurement chart creation process (see FIG. 10), the controller 7 of the image forming apparatus 1 may adjust the margin 204 of the leading end of the recording medium M in the color measurement chart P2 based only on the distance between the color measurement sensor 68 and the downstream roller 63. Alternatively, in place of step S11, the controller 7 may adjust the margin 204 of the leading end of the recording medium M in the color measurement chart P2 based only on a size of the downstream roller 63.

In the image forming apparatus 1, the distance between the color measurement sensor 68 and the downstream roller 63 and the size of the downstream roller 63 are fixed. Therefore, in step S11 of the color measurement chart creation process, the controller 7 does not need to calculate the same adjustment value each time. The adjustment value calculated in step S11 may be stored in the storage section 10, and in second and subsequent executions of the process, step S11 may be omitted.

In the color measurement chart creation process, when the recording medium M is thin paper (step S12; YES), the margin 204 of the leading end of the recording medium M in the color measurement chart P2 adjusted in step S11 is increased (step S13). Alternatively, without performing the processing in step S11, the margin 204 of the leading end of the recording medium M in the color measurement chart P2 may be adjusted based only on the paper type of the recording medium M.

In addition, the controller 7 does not necessarily need to proceed to step S17 after performing the processing of steps S11 to S16. For example, the controller 7 may perform the processing in steps S11 to S16 in advance to store the image data for creating the color measurement chart, the image data being provided with the cutting region 203, and may later create the color measurement chart P2 based on the image data for creating the color measurement chart. Also, when creating the color measurement chart P2, the controller 7 may provide the cutting region 203 by adjusting the timing at which the color measurement image 200 is formed.

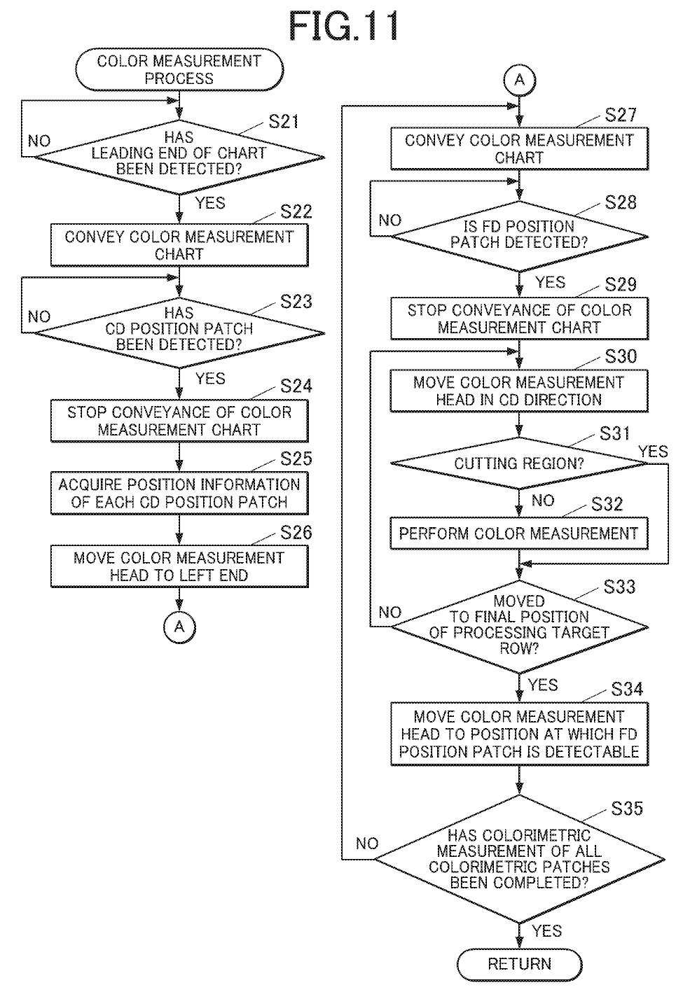

FIG. 11 is a flowchart showing details of the color measurement processing in step S3.

The controller 7 drives the first motor 65 to move the color measurement head 61 in the CD direction in advance so that the position sensor 69 is positioned to be able to detect the CD position patch 202a at the left end of the color measurement chart P2.

The controller 7 determines whether the leading-end detection sensor 64 has detected the leading end of the transported color measurement chart P2 (step S21). When the leading-end detection sensor 64 detects the leading end of the color measurement chart P2 (step S21; YES), the process proceeds to step S22. In step S22, the controller 7 drives the second motor 66 and the third motor 67 to cause the upstream roller 62 and the downstream roller 63 to transport the color measurement chart P2 in the FD direction.

Next, the controller 7 determines whether the position sensor 69 has detected the CD position patch 202a at the left end of the color measurement chart P2 (step S23). When the position sensor 69 detects the CD position patch 202a at the left end (step S23; YES), the controller 7 controls driving of the second motor 66 and the third motor 67 to stop transporting the color measurement chart P2 (step S24).

Next, the controller 7 drives the first motor 65 to move the color measurement head 61 from the left end to the right end, and acquires the position information for each CD position patch 202a from the position sensor 69 (step S25). The controller 7 calculates, from the position information of each CD position patch 202a, the size, color measurement timing, and the like of the color measurement patch 201, and uses the calculated values for the color measurement.

Next, the controller 7 drives the first motor 65 to move the color measurement head 61 to the left end in the CD direction so that the position sensor 69 is at the position at which the FD position patch 202b on the left side of the color measurement chart P2 can be detected (step S26).

Next, the controller 7 drives the second motor 66 and the third motor 67 to cause the upstream roller 62 and the downstream roller 63 to transport the color measurement chart P2 in the FD direction (step S27).

Next, the controller 7 determines whether the position sensor 69 has detected the FD position patch 202b of the color measurement chart P2 (step S28). If the position sensor 69 detects the FD position patch 202b (step S28; YES), the controller 7 controls driving of the second motor 66 and the third motor 67 to stop transport of the color measurement chart P2 (step S29).

Next, the controller 7 drives the first motor 65 to move the color measurement head 61 (color measurement sensor 68) in the CD direction (step S30). The controller 7 moves the color measurement sensor 68 to a position at which the next color measurement patch 201 can be measured. However, in the cutting region 203, the controller 7 moves the color measurement sensor 68 to a position corresponding to the next color measurement patch 201. When the processing target row is an odd-numbered row, the controller 7 moves the color measurement sensor 68 from left to right. When the processing target row is an even-numbered row, the controller 7 moves the color measurement sensor 68 from right to left.

Next, based on the position information of the cutting region 203 stored in the storage section 10, the controller 7 determines whether or not a portion of the color measurement chart P2 facing the color measurement sensor 68 is the cutting region 203 (step S31). If the portion of the color measurement chart P2 facing the color measurement sensor 68 is not the cutting region 203 (step S31; NO), the controller 7 controls the color measurement sensor 68 to perform the color measurement on the color measurement patch 201 (step S32). The controller 7 causes the storage section 10 to store, in association with each other, information for specifying the color measurement patch 201 that has been subjected to the color measurement and the colorimetric value (e.g., L* a* b* value) obtained from the color measurement patch 201.

After step S32 or in step S31, in a case where a portion of the color measurement chart P2 facing the color measurement sensor 68 is the cutting region 203 (step S31; YES), the process proceeds to step S33. In step S33, the controller 7 determines whether the color measurement sensor 68 has moved to a final position of the row to be processed. Specifically, when the color measurement patches 201 are arranged in the row to be processed, the controller 7 determines whether the last color measurement patch 201 in the row to be processed has been measured. In addition, when the row to be processed corresponds to the cutting region 203 extending in the CD direction, the controller 7 determines whether the color measurement sensor 68 has moved to the position corresponding to the last color measurement patch 201 of the row to be processed.

When the color measurement sensor 68 has not moved to the final position of the row to be processed (step S33; NO), the process returns to step S30.

In step S33, if the color measurement sensor 68 has moved to the final position of the row to be processed (step S33; YES), the process proceeds to step S34. In step S34, the controller 7 drives the first motor 65 to move the color measurement head 61 in the CD direction to a position at which the position sensor 69 can detect the FD position patch 202b of the color measurement chart P2. Specifically, the controller 7 moves the color measurement head 61 to the position (the left end or the right end) at which the FD position patch 202b on a final position side in a most recent row to be processed can be detected.

Next, the controller 7 determines whether the color measurement of all of the color measurement patches 201 has been completed by the color measurement sensor 68 (step S35). If there is the color measurement patch 201 for which the color measurement has not been completed (step S35; NO), the process returns to step S27. The controller 7 sets the processing target to the next row and repeats the processing.

In step S35, if the color measurement of all of the color measurement patches 201 has been completed (step S35; YES), the color measurement processing ends.

In step S31, when the portion of the color measurement chart P2 facing the color measurement sensor 68 is the cutting region 203, the controller 7 does not cause the color measurement sensor 68 to perform the color measurement. That is, the cutting region 203 of the color measurement chart P2 is, in the color measurement sensor 68, the region outside the color measurement target. For example, when the portion of the color measurement chart P2 facing the color measurement sensor 68 corresponds to the cutting region 203 extending in the FD direction, the color measurement by the color measurement sensor 68 is not performed. In addition, when the processing target row corresponds to the cutting region 203 extending in the CD direction, the color measurement by the color measurement sensor 68 for one row is not performed continuously by processing in steps S30 to S33.

In the color measurement processing, the cutting region 203 of the color measurement chart P2 is excluded from the color measurement. Alternatively, the controller 7 may omit the determination in step S31, perform the color measurement on the cutting region 203 using the color measurement sensor 68, and discard the colorimetric data corresponding to the cutting region 203.

When a malfunction occurs in the color measurement performed by the color measurement device 6 (inline colorimeter), the controller 7 of the image forming apparatus 1 may, for example, cause a warning to be displayed on the display part 9 to prompt the user to perform the color measurement using the offline colorimeter 13. Possible causes of the malfunction in the color measurement device 6 include, for example, the malfunction or the failure of the color measurement sensor 68, and scratches or contamination on the color measurement chart P2. In addition, the user may visually inspect the color measurement chart P2 to determine whether the color measurement patch 201 has the image defect, scratch, dirt, or the like.

When a color measurement malfunction occurs in the color measurement device 6, the user cuts the color measurement chart P2 at the cutting region 203 and sets the cut recording medium M into the offline colorimeter 13. The offline colorimeter 13 performs the color measurement on the plurality of color measurement patches 201 on the cut recording medium M to generate the colorimetric data. The offline colorimeter 13 stores, for each of the plurality of color measurement patches 201, the information for identifying the color measurement patch 201 and the colorimetric value (e.g., L*a*b* value) obtained from the color measurement patch 201, in association with each other. The PC 12 acquires the colorimetric data from the offline colorimeter 13. For the same color measurement patch 201, the PC 12 compares the colorimetric data obtained by the color measurement device 6 with the colorimetric data obtained from the offline colorimeter 13, and uses the comparison result for color management (e.g., creation of the ICC profile and color verification) of the image forming apparatus 1. As described above, when there is no problem with the result of the color measurement performed by the offline colorimeter 13, the colorimetric data obtained by the offline colorimeter 13 can be used for color management.

When there is no abnormality such as the scratch or contamination on the color measurement chart P2 but the malfunction has occurred in the color measurement by the color measurement device 6 due to the abnormality occurring in the color measurement device 6 (inline colorimeter), the process may be re-executed from creating the color measurement chart P2 after removing the cause of the malfunction of the color measurement device 6 (color measurement sensor 68), and the color measurement by the color measurement device 6 may be re-executed.

If the color measurement by the color measurement device 6 malfunctions due to an abnormality such as an obvious scratch or stain on the color measurement chart P2, there is a high possibility that the color measurement by the offline colorimeter 13 will also fail. In this case, it is desirable to remove a cause of the abnormality of the image forming section 4 (image forming apparatus 1), redo processing starting from creation of the color measurement chart P2, and re-perform the color measurement by the color measurement device 6. If the malfunction still occurs as a result of re-performing the color measurement by the color measurement device 6, the color measurement is to be performed using the offline colorimeter 13.

If the color measurement by the color measurement device 6 malfunctions and the color measurement by the offline colorimeter 13 also malfunctions, it can be considered that the color measurement chart P2 has the abnormality. In this case, after removing the cause of the abnormality of the image forming section 4 (image forming apparatus 1), processing is redone from creation of the color measurement chart P2, and the color measurement by the color measurement device 6 is re-performed.

On the other hand, if no malfunction occurs in the color measurement performed by the color measurement device 6 (inline colorimeter), the controller 7 of the image forming apparatus 1 uses the colorimetric data of each color measurement patch 201 measured by the color measurement device 6 for the color management of the image forming apparatus 1. Computational processing related to the color management of the image forming apparatus 1 may be executed in the controller 7 or in the PC 12.

As described above, according to the present embodiment, the controller 7 of the image forming apparatus 1 causes the color measurement image 200 to be formed on the recording medium M so that the color measurement device 6 (first color measurer) can perform the color measurement of the color measurement image 200. At this time, in order to perform the color measurement on the color measurement image 200 with the offline colorimeter 13 (second color measurer), the controller 7 provides, in the color measurement image 200, the cutting region 203 for cutting the recording medium M (color measurement chart P2) on which the color measurement image 200 is formed. Thus, the controller 7 can also facilitate, in the offline colorimeter 13 located outside the conveyance route of the recording medium M of the image forming apparatus 1, the color measurement of the image to be subjected to the color measurement by the color measurement device 6 (inline colorimeter) provided in the conveyance route of the recording medium M of the image forming apparatus 1.

By cutting, at the cutting region 203, the recording medium M (color measurement chart P2) on which the color measurement image 200 is formed, the user can obtain the chart on which the color measurement can be performed by the offline colorimeter 13 (second color measurer) without cutting each color measurement patch 201. Thus, the offline colorimeter 13 can perform the color measurement on each cut recording medium M. Providing the cutting region 203 in the color measurement image 200 facilitates the color measurement by the offline colorimeter 13.

The cutting region 203 may be the region outside the color measurement target in at least one of the color measurement device 6 and the offline colorimeter 13. By setting the cutting region 203 as the region outside the color measurement target, the influence of providing the cutting region 203 in the color measurement image 200 on the color measurement performed by the color measurement device 6 and the offline colorimeter 13 can be minimized.

The controller 7 determines the cutting region 203 to be provided in the color measurement image 200 based on the size of the recording medium M that can be subjected to the color measurement by the offline colorimeter 13. Specifically, the controller 7 provides the cutting region 203 in the color measurement image 200 such that the size of the recording medium M after the recording medium M is cut at the cutting region 203 is equal to or less than the size of the recording medium M that can be subjected to the color measurement by the offline colorimeter 13. Thus, the offline colorimeter 13 can perform the color measurement on each cut recording medium M.

In the image forming section 4, in which the image is formed by ink ejection and UV curing, a predetermined amount of time is required for the image to stabilize. That is, in the image forming apparatus 1, it is necessary to stop conveyance of the recording medium M on which the color measurement image 200 has been formed, in front of the color measurement device 6, and to keep the recording medium M on standby. In view of the standby time after the image formation, the color measurement image 200 is preferably sized to fit within the single recording medium M.

According to the present embodiment, the controller 7 causes the color measurement image 200 to be formed on the single recording medium M so that the color measurement device 6 can perform the color measurement on the color measurement image 200, thereby minimizing standby time before the color measurement and enabling efficient color measurement of the color measurement image 200.

The controller 7 causes the mark (position patch 202) to be formed on the recording medium M to identify the position at which the color measurement device 6 performs the color measurement on the color measurement image 200. Since the controller 7 creates the color measurement chart P2 including the position patch 202, the color measurement accuracy with which the color measurement device 6 measures the color measurement patch 201 can be improved.

The controller 7 determines the size of the color measurement patch 201 (rectangular) based on the size of the color measurement device 6. Specifically, the controller 7 sets the size of the color measurement patch 201 to be larger than the reading region 68a of the color measurement sensor 68 so that, even if the recording medium M is slightly misaligned during conveyance, the color measurement by the color measurement sensor 68 can be performed.

The controller 7 adjusts, based on the distance in the conveyance direction of the recording medium M between the color measurement sensor 68 (reading section) and the downstream roller 63, the position of the color measurement image 200 with respect to the leading end of the recording medium M in the conveyance direction. Specifically, as the distance between the color measurement sensor 68 and the downstream roller 63 increases, the controller 7 positions the color measurement image 200 at a location farther from the leading end of the recording medium M. The controller 7 adjusts the position of the color measurement image 200 such that the color measurement by the color measurement sensor 68 starts after the leading end of the recording medium M (color measurement chart P2) is nipped by the nip of the downstream roller 63. Thus, the stable color measurement can be performed by the color measurement sensor 68.

When the size of the recording medium M is large, a beautiful image cannot be formed unless the number of color measurement patches 201 (i.e., the number of colors calibrated in color adjustment) is increased. Therefore, although it is necessary for the color measurement chart P2 to include the large number of color measurement patches 201, space on the recording medium M is limited. Therefore, the controller 7 adjusts the margin 204 of the leading end of the recording medium M such that the color measurement patches 201 required for the color measurement can be arranged.

The controller 7 adjusts, based on the size of the downstream roller 63, the position of the color measurement image 200 with respect to the leading end of the recording medium M in the conveyance direction. Specifically, as the size of the downstream roller 63 increases, the controller 7 positions the color measurement image 200 farther from the leading end of the recording medium M. The controller 7 adjusts the position of the color measurement image 200 such that the color measurement by the color measurement sensor 68 starts after the leading end of the recording medium M is nipped by the nip of the downstream roller 63. Thus, the stable color measurement can be performed by the color measurement sensor 68.

Note that, as information indicating the size of the downstream roller 63, the radius of the downstream roller 63 or the curvature of the downstream roller 63 may be used. Further, as the information indicating the size of the downstream roller 63, the diameter of the downstream roller 63 or the outer circumference thereof may be used.

The controller 7 adjusts, based on the paper type of the recording medium M, the position of the color measurement image 200 from the leading end of the recording medium M in the conveyance direction. When the recording medium M is thin paper, the recording medium M may flap before the leading end of the recording medium M is nipped by the nip of the downstream roller 63. Therefore, when the thin paper is used as the recording medium M, the controller 7 adjusts the position of the color measurement image 200 such that the distance in the conveyance direction from the leading end of the recording medium M to the color measurement image 200 is longer than that when the plain paper or the thick paper is used as the recording medium M. As a result, the color measurement sensor 68 can perform stable color measurement even for thin paper.

The controller 7 provides, on the color measurement image 200, the cutting line 205 (see FIG. 8) for cutting the cutting region 203. The user can cut the recording medium M by using the cutting line 205 on the color measurement chart P2 as a guide.

It should be noted that the descriptions in the above embodiments are merely examples of a control device, a control method, a control program, an image forming apparatus, and an image forming method, and the present disclosure is not limited thereto. The detailed configuration and operation of each unit constituting each device may be modified as appropriate without departing from the scope of the present disclosure.

In the above-described embodiment, when the controller 7 of the image forming apparatus 1 forms the color measurement image 200 on the recording medium M, the controller 7 provides the cutting region 203 in the color measurement image 200. Alternatively, the color measurement image (the image data for printing the color measurement chart) provided with the cutting region in advance may be prepared.

The computer-readable medium storing the program for executing each process is not limited to the example described above. Further, a carrier wave may be used as a medium for providing program data via a communication line.

Although embodiments of the present disclosure have been described and illustrated in detail, the disclosed embodiments are made for purposes of illustration and example only and not limitation. The scope of the present disclosure should be interpreted by terms of the appended claims.

What is claimed is:

1. A control device that controls an image forming apparatus to form an image on a recording medium, the control device comprising:
a hardware processor configured to cause the image to be formed on the recording medium in a state that a color measurement of the image can be performed by a first color measurer provided on a conveyance route on which the recording medium is conveyed,
wherein the hardware processor is configured to provide the image with a cutting region for cutting the recording medium on which the image is formed to perform the color measurement of the image in a second color measurer outside the conveyance route.

2. The control device according to claim 1, wherein the cutting region is a region outside a color measurement target in at least one of the first color measurer and the second color measurer.

3. The control device according to claim 1, wherein the hardware processor is configured to determine the cutting region based on a size of the recording medium on which the second color measurer is capable of performing the color measurement.

4. The control device according to claim 1, wherein the hardware processor is configured to form the image on a single recording medium in a state that the first color measurer is capable of performing the color measurement on the image.

5. The control device according to claim 1, wherein the hardware processor is configured to form on a recording medium a mark with which a position is determined when the first color measurer performs the color measurement on the image.

6. The control device according to claim 1, wherein,
the image includes a plurality of rectangles of different colors, and
the hardware processor determines a size of the rectangle based on a size of the first color measurer.

7. The control device according to claim 1, wherein,
the first color measurer includes, a reader and a roller in this order from an upstream side in a conveyance direction of the recording medium, and
the hardware processor forms on the recording medium the image in a state that the first color measurer is capable of performing the color measurement on the image by adjusting, based on a distance in the conveyance direction between the reader and the roller, a position of the image from a leading end of the recording medium in the conveyance direction.

8. The control device according to claim 1, wherein,
the first color measurer includes, a reader and a roller in this order from an upstream side in a conveyance direction of the recording medium, and
the hardware processor forms on the recording medium the image in a state that the first color measurer is capable of performing the color measurement on the image by adjusting, based on a size of the roller, a position of the image from a leading end of the recording medium in the conveyance direction.

9. The control device according to claim 8, wherein the hardware processor adjusts the position of the image from the leading end of the recording medium in the conveyance direction, based on a radius or curvature of the roller.

10. The control device according to claim 1, wherein,
the first color measurer includes, a reader and a roller in this order from an upstream side in a conveyance direction of the recording medium, and
the hardware processor forms on the recording medium the image in a state that the first color measurer is capable of performing the color measurement on the image by adjusting, based on a paper type of the recording medium, a position of the image from a leading end of the recording medium in the conveyance direction.

11. The control device according to claim 10, wherein the hardware processor adjusts a position of the image in a state that when thin paper is used as the recording medium, a distance in the conveyance direction from the leading end of the recording medium to the image is longer than when plain paper or thick paper is used as the recording medium.

12. The control device according to claim 1, wherein the hardware processor provides a cutting line for cutting the cutting region in the image.

13. A control method for controlling an image forming apparatus to form an image on a recording medium, the control method comprising:
controlling to cause the image to be formed on the recording medium in a state that a color measurement of the image can be performed by a first color measurer provided on a conveyance route on which the recording medium is conveyed,
wherein in the controlling, the image is provided with a cutting region for cutting the recording medium on which the image is formed to perform the color measurement of the image in a second color measurer outside the conveyance route.

14. A non-transitory computer readable storage medium comprising a control program that causes a computer of a control device that controls an image forming apparatus to form an image on a recording medium to execute the control method according to claim 13.

15. An image forming apparatus comprising:
an image former; and
a control device configured to cause the image former to form an image on a recording medium,
wherein,
the control device includes a hardware processor configured to cause the image to be formed on the recording medium in a state that a color measurement of the image can be performed by a first color measurer provided on a conveyance route on which the recording medium is conveyed, and
the hardware processor is configured to provide the image with a cutting region for cutting the recording medium on which the image is formed to perform the color measurement of the image in a second color measurer outside the conveyance route.

16. An image forming method in which an image forming apparatus forms an image on a recording medium, the image forming method comprising:
controlling to cause the image to be formed on the recording medium in a state that a color measurement of the image can be performed by a first color measurer provided on a conveyance route on which the recording medium is conveyed,
wherein in the controlling, the image is provided with a cutting region for cutting the recording medium on which the image is formed to perform the color measurement of the image in a second color measurer outside the conveyance route.
